(19) United States
(12) Patent Application Publication
(10) Pub. No.: US 2010/0276448 A1
(43) Pub. Date: Nov. 4, 2010

(54) DEVICE FOR DISPENSING FLUID SUBSTANCES ENCLOSED IN SEALED CONDITIONS IN A BAG WITH GUIDED DEFORMATION

(75) Inventor: Matteo MORETTI, Crema(CR) (IT)

Correspondence Address: OBLON, SPIVAK, MCCLELLAND MAIER & NEUSTADT, L.L.P., 1940 DUKE STREET, ALEXANDRIA, VA, 22314, US

(73) Assignee: LUMSON S.p.A, Capergnanica (IT)

(21) Appl. No.: 12/762,700

(22) Filed: Apr. 19, 2010

(30) Foreign Application Priority Data
Apr. 30, 2009 (IT) MI2009A000751

(51) Int. Cl. B67D 7/60; B65D 37/00

(52) U.S. Cl. 222/105

(57) ABSTRACT

A device for dispensing fluid substances, comprising a rigid container (5) having a neck (6) delimiting an opening giving access to the cavity of the container, a bag (9) made of thermoplastic material housed inside the container (5), a hermetic pump (P) connected in sealed conditions to the bag and which can be activated manually to draw off a fluid substance (F) from the bag and feed it to the outside via a stem of the pump, where inside said bag is an element with substantially axial development suitable for guiding crumpling of the bag due to emptying thereof by means of said pump.

The present invention concerns a device for dispensing fluid substances enclosed in sealed conditions in a deformable bag combined with a manual dispensing pump.

More specifically it relates to a device in which extraction of the bag from the container is performed simply and rapidly.

It is common practice to enclose fluid substances (both liquid and creamy) in containers from which said substances are dispensed by the manual activation of a small pump mounted on the inlet of a respective container. Activation of the pump causes draw-off of a quantity of fluid substance from the container in which—if the container is rigid—a vacuum would form which would prevent further draw-offs and dispensing of the substance if there were no provision for the inlet of air into the container (which generally occurs in the pump contact and sliding areas on the body of said pump) or if the container did not comprise a movable bottom along the internal cylindrical surface of the container (for example, see patents U.S. Pat. No. 4,691,847, U.S. Pat. No. 4,694,977 and U.S. Pat. No. 5,971,224): the latter system for compensation of the volume of the containers to reduce the internal volume thereof and maintain the internal pressure constant is, however, somewhat laborious and expensive.

In many cases it is expedient or necessary for the fluid substance dispensed by means of a pump never to come into contact with the atmosphere inside the container (with dispenser pump mounted on it): keeping the fluid away from contact with the atmosphere is important if there is the need not to alter the composition of the fluid inside the bottle, or if the fluid substance in the container must remain sterile. To obtain this, the patent U.S. Pat. No. 3,420,413 has proposed a device comprising a bag containing the fluid substance which must remain isolated (from the atmosphere) inside the bag which (see column 4, lines 22-28) is made of elastically deformable flexible material and has a neck on which a supporting element (having a shaped opening for housing a pump) is applied in sealed conditions after the bag has been filled with the fluid substance to be dispensed: a pump is then mounted in sealed conditions on the above-mentioned supporting element, thus preventing contamination of the fluid substance with the air (column 5, lines 15-38). The bag containing the fluid substance and with the hermetic pump mounted in sealed conditions on its neck is then introduced into a rigid container (obviously being very careful to ensure that the free edge of the rigid container does not come into contact with the bag full of fluid substance, in order not to break the bag) on which the above-mentioned supporting element is then positioned and fixed (column 5, lines 56-61). Between the outer surface of the bag and the inner surface of the rigid container, a cavity therefore forms which communicates with the atmosphere via a hole obtained on the bottom of the container; in this way, when the fluid substance is drawn from the bag by activation of the pump, the bag will be squeezed by the atmospheric pressure and the fluid substance can therefore be easily drawn off and expelled to the outside by means of the pump (column 5, lines 70-73). The main drawback of the above-mentioned device is that the deformable bag must be filled with fluid substance before the bag is introduced into the respective rigid container and that the operation for introducing the bag into the container is very delicate because the bag can easily tear during insertion into the container.

The Japanese patent applications JP 05 031790A and JP 05 031791A published on Sep. 2, 1993 describe how it is possible to produce a bag made of elastically deformable material directly inside a rigid container. For said purpose an elongated tube (made of thermoplastic material and having a hollow elongated cylindrical body, open at one end where the tube has a neck from which a flange radially protrudes) is inserted in a rigid container having an inlet from which a neck extends on the free edge of which the tube flange rests; the latter is heated and then inflated inside the container until forming a bag, the outer surface of which adheres (at least for a large part of its surface) to the inner surface of the container. Also the bag thus obtained has a neck, at least one end portion of which is provided with longitudinal ribs protruding towards the outside, while radial ribs or lugs protrude from the tube flange surface facing towards the free edge of the neck of the container in which the bag is inserted: said ribs or lugs define passages for the air which, from the outside, penetrates between the container and the bag to allow the latter to be squeezed or deformed inwards during dispensing of the fluid substance to the outside via the pump, thus avoiding a vacuum forming inside the bag which would prevent dispensing of the fluid substance.

The documents EP0596142 and WO 00/04998 illustrate a pump associated with a suck-up tube provided with grooves. In addition to acting as a guide for deformation of the bag, the tube via its grooves permits dispensing of almost all the product.

It has however been observed that in certain circumstances the bag, as it contracts, can push against the body of the pump, adhering to it and thus creating pockets of product which are therefore not dispensed.

Said pockets constitute bulges which make it difficult to extract the used bag from the container.

The object of the present invention is to produce a device of the type mentioned, which is able to dispense, in any condition, a greater quantity of product with respect to the traditional devices.

A further object of the present invention is to facilitate extraction of the bag from the container, via its neck.

These and other objects are achieved by producing a device in accordance with the technical teachings of the attached claims.

Further characteristics and advantages of the invention will become evident from the description of a preferred but not exclusive embodiment of the device, illustrated by way of non-limiting example in the accompanying drawings, in which:

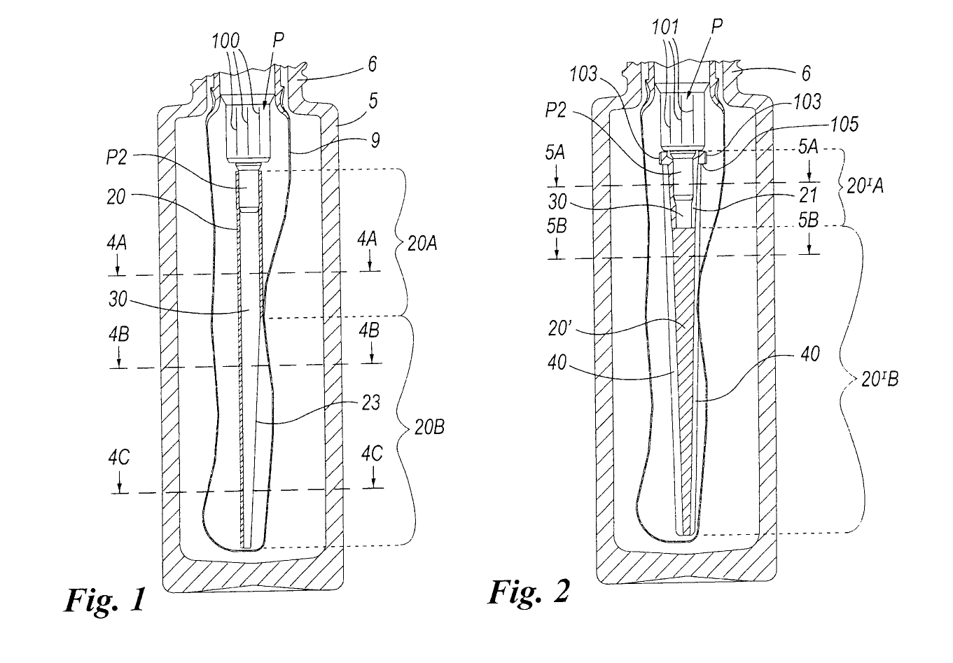

FIG. 1 shows in side elevation a section of the device according to the present invention where the pump is shown only partially;

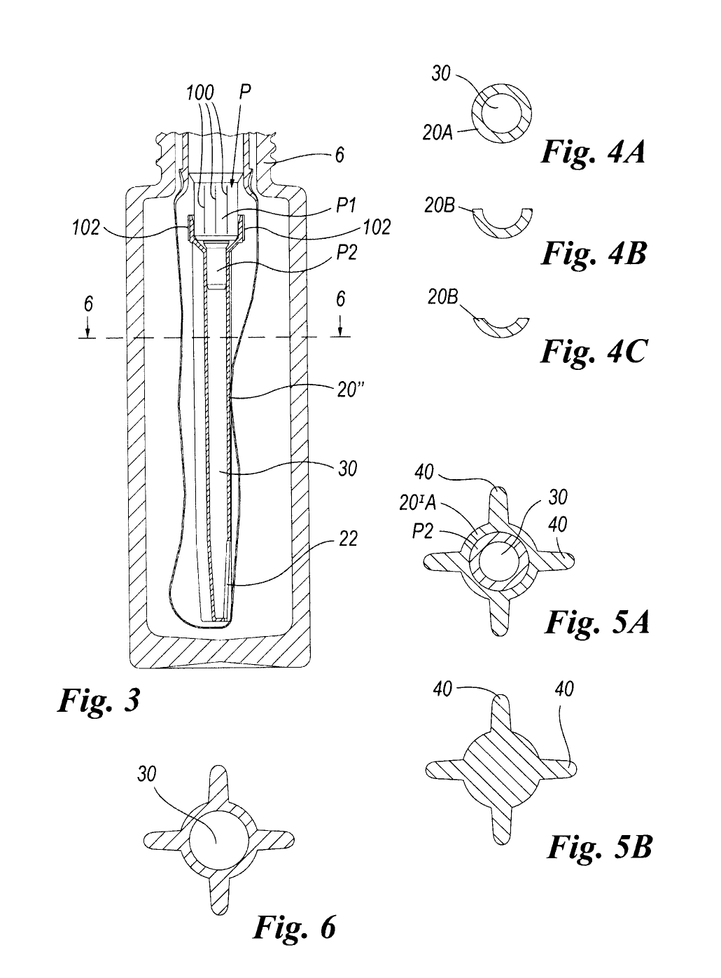

FIGS. 2 and 3 are sections analogous to those of FIG. 1, in which two alternative forms of embodiment of the invention are represented;

FIGS. 4A, 4B, 4C, 5A, 5B and 6 show partial sections, taken along the respective section lines in FIGS. 1, 2 and 3, of details of the invention;

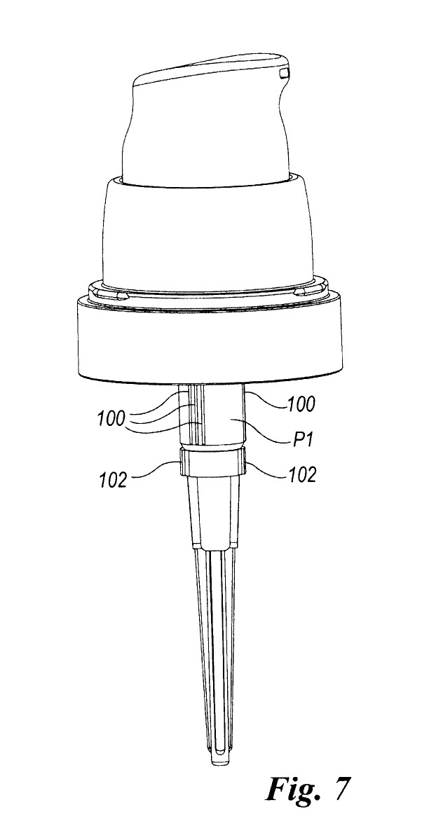

FIG. 7 shows again another alternative embodiment of the present invention.

Reference is first made to FIG. 1.
Here a deformable bag 9 is shown produced by direct inflation in a container 5 surrounding it. The container has a neck 6 inside which the bag, still in the form of a heated tube, is inserted before being formed by inflation of the tube as known in the art.

The bag 9 is coupled in airtight conditions in a manner known in the art to a pump P, only partially illustrated in the figures, of the hermetic or airless type. The term hermetic pump indicates a pump which during dispensing of the product and when at rest does not permit in any way the passage of air inside the bag.

Said pumps are commonly used coupled both with deformable bags, as in this case, and with containers with movable bottom.

In fact the volume of product dispensed determines a deformation of the bag or raising of the bottom.

The product or fluid inside the bag therefore remains completely isolated from the external environment until it is dispensed.

The pump P has a beaker-shaped body P1 inside which the pump cylinder runs. From the beaker-shaped body, an internally hollow cylindrical element P2 protrudes comprising a suck-up hole, obstructed when at rest by a one-way valve. On the cylindrical element P2 a suck-up tube 20 is fitted, hollow inside and made of a material that gives it a certain rigidity. The suck-up tube has an axial development and a first portion 20A with hollow cylindrical section (FIG. 4A) connected to a second portion 20B with U-shaped section. The U-shaped section (FIG. 4B) is tapered towards the bottom of the container (FIG. 4C). Substantially the suck-up tube of FIG. 1 takes the form of a hollow cylinder, sectioned by a plane not parallel to its axis.

The inclination of said plane with respect to the axis is between 5 and 15°.

The suck-up tube has a length such that it reaches the bottom of the container without touching it.

Substantially the suck-up tube, given its substantial axial rigidity, is able to ‘guide’ deformation of the bag 9 resulting from dispensing of the product contained in it, preventing it from crumpling in on itself and from assuming an overhead lateral dimension much larger than the diameter of the hole. In this way the bag can easily be extracted, without forcing, from the hole of the container.

It should be noted that advantageously the pump is securely connected to the bag so that when the pump is moved away from the container, the bag is simultaneously extracted from the container.

The presence of the tube around which the bag is compacted considerably facilitates the extraction operations.

According to the present invention the body of the pump P1 inside which the pump piston runs is provided externally with means suitable for preventing retention of the bag on the pump body, resulting from possible squeezing of the bag on the body.

Said means shown in the figures have grooves 100 which, even when the bag is pressed against the pump body, form passages or channels for dispensing of the fluid which therefore always remains in communication with the pump suction hole. This avoids the formation of pockets which would prevent complete dispensing of the product.

Obviously the above grooves can be replaced by fins 101, or other means suitable for the purpose (see FIG. 2 which shows a different embodiment of the invention).

The tube 20′ in said further embodiment has a first portion 20′A mounted and locked by press-fitting on part P2 of the pump. The first portion is hollow inside and is connected to a second portion 20′B without cavity. Near the interconnection area between the first and the second portion, there is an aperture 21 communicating with the cavity of the first portion 20′A and emerging laterally to the tube.

Advantageously in said embodiment there is at least one lateral fin (in particular four arranged in the shape of a cross—see section 5A and 5B—) which develop throughout the entire height of the tube.

As previously, the section of the tube is tapered towards the bottom of the container.

Furthermore the suck-up tube has a ring 105, which when mounted on the pump is aligned with the surface of the pump body. Said ring is also provided with fins 103, which prevent the formation of pockets.

An alternative to the preceding embodiments is shown in FIG. 3. Substantially said embodiment is very similar to the one described previously (and the analogous parts will not be described), but the cavity inside the tube 20″ in this case runs throughout its length. Furthermore the upper part (in FIG. 3) of the suck-up tube is provided with a cup-shaped portion 20″C which is fitted on the outer portion of the beaker-shaped body of the pump, to improve locking of the tube to the pump.

Said solution can also be provided, with the appropriate modifications, also in the preceding embodiments.

Again in said embodiment, the cavity of the tube communicates with the bag via a lateral opening 22, this time positioned near the bottom of the container.

As previously, also in the embodiment of FIG. 3 fins are provided arranged for example in the shape of a cross (see section of FIG. 6).

The fins, as in the previous cases, improve the flow of the fluid to be dispensed towards the corresponding opening of the suck-up tube.

Also in this case, on part P1, grooves 100 are provided. They are repeated also on the annular portion 106 of the tube, which is fitted on the portion P1 of the pump.

FIG. 4 shows an embodiment similar to that of FIG. 2. Instead of the fins on the pump body and on the ring of the suck-up tube, grooves 100 and 102 are provided.

Operation of the invention as described is substantially the following.

During dispensing of the product, the bag empties and consequently crumples, pressed by the external atmospheric pressure. The tube ‘guides’ crumpling of the bag caused by the emptying thereof, thus stopping the bottom of the bag from moving up to the pump as a result of emptying of the bag. Substantially it prevents the bag, as it moves near the pump, from assuming a lateral dimension far superior to the diameter of the container opening, thus making extraction difficult.

It should also be noted that the suck-up tube acts as a guide element for deformation of the bag.

If the bag comes into contact with the body of the pump P1, the fins 101 or the grooves 100 maintain the communication between the pocket of product, which forms as a result of squeezing of the bag, and the pump suck-up hole, thus permitting dispensing also of the product trapped in the pocket.

It is important to note that any elongated element, also positioned freely inside the bag, performs the function of guiding deformation of the bag.

Substantially the tube or said elongated element, with substantially axial development, must have a rigidity such as to stop the bottom of the bag from moving up to the pump as a result of emptying of the bag, thus preventing the bag from assuming a radial dimension far exceeding the diameter of the opening of the container 5.

The elongated element can be connected or not to the pump. It must advantageously have a length comparable to the height of the bag.

1. A device for dispensing fluid substances, comprising a rigid container (5) having a neck (6) delimiting an opening giving access to the cavity of the container, a bag (9) made of thermoplastic material housed inside the container (5), a hermetic pump (P) connected in sealed conditions to the bag and which can be activated manually to draw off a fluid substance from the bag and feed it to the outside via a stem of the pump, inside said bag (9) a suck-up tube (20, 20^{I}, 20^{II}) being provided associated with the pump, which has a substantially axial development and is suitable for guiding crumpling of the bag (9) caused by the emptying thereof by means of said pump, characterised in that the pump body, at least on part of its outer surface, has means suitable for preventing adhesion between pump body and bag consequent upon emptying of the latter.

2. Device as claimed in the preceding claim wherein said means comprise grooves provided outside the pump body.

3. Device as claimed in the preceding claim wherein said means comprise fins provided on the outer surface of the pump body.

4. Device as claimed in the preceding claim wherein said element with axial development has a rigidity such as to maintain a substantially elongated configuration even when pressed by the substantially emptied bag, therefore stopping the bottom of the bag from moving up to the pump consequent upon emptying of the bag.

5. Device as claimed in the preceding claim wherein said element with axial development is a suck-up tube having a length such that when the pump (9) is positioned on the container (5), one end of it is near the bottom of the latter but without touching it.

6. Device as claimed in one or more of the preceding claims wherein said suck-up tube has an axial channel (30) for passage of the fluid emerging into an opening (21, 22, 23) positioned in the vicinity of one end of said tube near the bottom of the container.

7. Device as claimed in one or more of the preceding claims wherein said tube has at least a lateral fin (40) which develops throughout its length.

8. Device as claimed in one or more of the preceding claims wherein said stem has a first axially hollow section (20^{I}A), suitable for hooking to the body of said pump, and a second section (20^{I}B) without cavity, facing towards the bottom of the container.

9. Device as claimed in the preceding claim wherein said axially hollow section (20^{I}A) has an opening (21) facing towards the bag obtained in said section without cavity.

10. Device as claimed in the preceding claim wherein at least said second section (20^{I}B) is provided with at least one fin which develops throughout its length.

11. Device as claimed in claim 4, wherein said second section is tapered towards the bottom of the container.

12. Device as claimed in one or more of the preceding claims wherein said opening is obtained laterally to said suck-up tube.

13. Device as claimed in one or more of the preceding claims wherein said tube has a first cylindrical section (20A) hollow inside (30), and a second section (20B) with U-shaped section projecting towards the bottom of the container.

14. Device as claimed in the preceding claim wherein said second section is tapered towards the bottom of the container.

15. Device as claimed in one or more of the preceding claims wherein said suck-up tube has an annular portion suitable for overlapping a cylindrical element of the pump in which a suck-up hole is provided and/or overlapping the body of the pump, said annular portion also having said means suitable for preventing adhesion of the bag.
